(19) United States
(12) Patent Application Publication
(10) Pub. No.: US 2009/0028313 A1
(43) Pub. Date: Jan. 29, 2009

(54) Method of Transmitting an Indication Inhibiting a Messaging Service

(75) Inventor: Bertrand Bouvet, Perros-Guirec (FR)

Correspondence Address: COHEN, PONTANI, LIEBERMAN & PAVANE LLP, 551 FIFTH AVENUE, SUITE 1210, NEW YORK, NY, 10176, US

(73) Assignee: France Telecom, Paris (FR)

(21) Appl. No.: 12/224,694

(22) PCT Filed: Feb. 21, 2007
(86) PCT No.: PCT/FR2007/050831

§ 371 Date: Sep. 2, 2008

(30) Foreign Application Priority Data
Mar. 2, 2006 (FR) 0601901

(51) Int. Cl. H04M 3/42

(52) U.S. Cl. 379/201.02

(57) ABSTRACT

A method of transmitting an indication inhibiting at least one service associated with a called device, the method including a step for generating a call signal (4001) in order to set up a communication between a calling device and the called device via at least one communication network. Such a method also comprises a substitution step (4005), to be executed when said call signal comprises an inhibiting command, and during which said inhibiting command is replaced by said inhibiting indication.

### 1. FIELD OF THE INVENTION

The field of the invention is that of telephone or videophone telecommunications over wired telecommunication networks (for example a fixed telephony network) or wireless telecommunication networks (for example a mobile telephony network).

More specifically, the invention relates to the deactivation, initiated by a calling user, of services associated with the abovementioned networks offered to a called user.

### 2. SOLUTIONS OF THE PRIOR ART

Most telecommunications operators on circuit and/or packet mode fixed or mobile networks now offer, with no added cost, the voice messaging service with implementation in the network. The benefits of such a network voice messaging service are many.

From the point of view of the telephony operators, the benefit is considerable since, with this network voice messaging service, the telecommunications operators offer their customers a better quality global service, to be compared with a simple telephone line with a basic telephony service.

Furthermore, the clients no longer have to invest in telephone voice answering terminals which very quickly go out of fashion and which are bulky (notably because of their dimensions, power supply wires, connection to the telephone socket). Furthermore, a network voice messaging service could be activated by several events or conditions, notably including failure to answer (as for the answering machines local to the terminal installations), a busy condition, unconditional call transfer, anonymous call detection. Such a network messaging service can also be activated according to the calling number or the day and/or time of the call.

When a calling party wants to reach someone, he wants to have a real time bidirectional communication with his contact. Being redirected to a voice messaging service is not the same as the “basic” telephone service and therefore does not meet the calling party's expectations.

In practice, often, the calling party wants to have a real time bidirectional communication with the called party, for example to obtain information immediately. In this example, if the called party does not answer or is busy, the calling party will not be provided with the desired information by being forwarded to the called party's voice messaging. This is why, in most cases, the calling party does not leave a message or leaves a very short message.

However, the act of being connected with a voice messaging is currently billed to the calling party at the same cost as an actual real time bidirectional communication. Thus, in cases where the calling party has no desire to be connected with a voice messaging, he is still billed from the first second (and often with an indivisible first minute mechanism) to hear the called party's greeting announcement.

Moreover, it is worth noting that the voice messaging systems are starting to be enriched with the video component, with videophone services over fixed and mobile networks beginning to become commercially available. The services and the implementation mechanisms are the same. This is why no distinction is drawn between these two messaging systems hereinafter.

### 3. OBJECTIVES OF THE INVENTION

The main objective of the invention is to overcome these drawbacks of the prior art.

More specifically, one objective of the invention, in at least one of its embodiments, is to provide a technique for managing at least one service associated with a called device which enables the calling party to act on the service.

Another objective of the invention, in at least one of its embodiments, is to implement such a technique which enables, when the service is a voice and/or video messaging service, the calling party to be directed to a messaging service only when it is necessary to him.

Another objective of the invention, in at least one of its embodiments, is to implement such a technique which enables, when the service is a voice and/or video messaging service, the calling party, wishing only to set up a bidirectional communication, not to be billed when he does not succeed in reaching the called party.

Yet another objective of the invention, in at least one of its embodiments, is to provide such a technique which is simple and inexpensive to implement.

### 4. EXPLANATION OF THE INVENTION

At least some of these objectives, and others that will become apparent hereinafter, are achieved with the aid of a method of transmitting an indication inhibiting at least one service associated with a called device, the method including a step for generating a call signal in order to set up a communication between a calling device and the called device via at least one communication network.

According to the invention, such a method also comprises a substitution step, to be executed when said call signal comprises an inhibiting command, and during which the inhibiting command is replaced by the inhibiting indication.

The general principle of the invention is to generate and transmit, on reception of a command from a calling user, a call signal comprising an indication inhibiting at least one service associated with a called device.

Thus, the service associated with the called device can be a voice and/or video messaging service. According to variants, this service can also be any other service, for example:
a time delay triggered on the call making it possible to broadcast advertising messages to a calling user; or
a call forwarding from the number of a called user to another number; or
a notification to the called user of the call (for example by text message, email, instant messaging, etc.).

Thus, the invention proposes a technique of explicitly inhibiting (or deactivating), on each call, a service, for example a voice and/or video messaging service (for example telephone or videophone) associated with the line (fixed or mobile) of a called device, implemented by a user of a calling device (for example a telephone terminal or a videophone terminal).

The method of transmitting an inhibiting indication according to the invention can be used equally in the context of messaging services deployed by the telecommunications operators and in the case of messaging services deployed by the customers themselves locally, on their terminal installation, notably by the addition of telephone or videophone answering machine or specific equipment on company PBXs. This transmission method can also be used equally in the context of any other service as indicated hereinabove.

According to a first embodiment of the invention, the substitution step is to be executed by a call signal management unit included in a network element to which the calling device is connected.

Thus, in the context of this first embodiment, the calling device does not need to be modified or adapted to implement the present invention. It is therefore possible, for example, to use conventional telephone terminals.

According to a second embodiment of the invention, the substitution step is to be executed by a call signal management unit included in the calling device.

Thus, in the context of this second embodiment, a network element to which the calling device is connected in order to link it to the communication network does not need to be modified or adapted to implement the present invention. It is therefore possible, for example, to use a conventional network element to link the calling device to the communication network.

According to a characteristic of the invention, the inhibiting command is a prefix dialed by a user of the calling device on generation of the call signal.

Thus, this inhibiting command is simple and quick to implement. Also, the entry of this inhibiting command according to the invention does not require the calling device to be modified accordingly.

Obviously, depending on variants, the inhibiting command can also be:
a suffix dialed by the user;
a choice in a menu by the user on configuration;
a pressing of a dedicated key by the user;
a particular configuration of the calling device.

According to another characteristic of the invention, the inhibiting indication is included in at least one field which takes a first value or a second value according to the inhibiting command.

For example, the first value is “TRUE” and the second value is “FALSE”.

According to a characteristic of the invention, the transmission method also comprises a step for verifying at least one authorization of the calling device and/or of a user of the calling device to inhibit said at least one service.

Thus, it is possible to check the use of the service inhibiting technique and it is therefore possible to have this use depend, for example, on the taking-out of a subscription or any other condition.

According to a characteristic of the invention, the network element belongs to the group comprising:

LS elements;

PBX elements;

MSC elements;

VoIP GK elements;

“modem/router” type elements;

BAS elements;

DSLAM elements;

Proxy SIP elements;

Call Agent MGCP elements;

“Intelligent network” type elements;

Server Node elements.

According to another characteristic of the invention, the call signal belongs to the group comprising:

the messages compliant with the ISDN protocol;

the messages compliant with the ISUP protocol;

the messages compliant with the Si H323 protocol;

the messages compliant with the Si SIP protocol;

the messages compliant with the MGCP protocol;

the IAM messages;

the INVITE messages;

the ISDN SETUP messages;

the H.323 SETUP messages;

the MGCP CRCX messages.

The invention also relates to a computer program product that can be downloaded from a communication network and/or stored on a medium that can be read by computer and/or executed by a microprocessor, the computer program product comprising program code instructions for implementing the transmission method as described previously.

The invention also relates to a network element comprising means of receiving a call signal generated by a calling device in order to set up a call with a called device via at least one communication network, the network element also comprising:
means of detecting the presence of a command inhibiting at least one service associated with the called device in said call signal;
means of generating a modified call signal in which, if an inhibiting command is present in the call signal, said inhibiting command is replaced by an inhibiting indication.

Such a network element can in particular implement, at least partly, the transmission method as previously described.

The invention also relates to a calling device comprising means of generating a call signal in order to set up a call with a called device via at least one communication network,

the calling device also comprising:
means of adding a command inhibiting at least one service associated with the called device to the call signal.

According to a characteristic of the invention, the calling device also comprises a call signal management unit comprising:
means of receiving a call signal;
means of detecting the presence of the inhibiting command in the call signal;
means of generating a modified call signal in which, if an inhibiting command is present in the call signal, said inhibiting command is replaced by an inhibiting indication.

Such a calling device can in particular implement, at least partly, the transmission method as previously described.

The invention also relates to a method of processing an indication inhibiting at least one service associated with a called device, a calling device being intended to generate a call signal in order to set up a call with the called device via at least one communication network, said processing method comprising a step for inhibiting said service, said step being intended to be executed when the call signal comprises said inhibiting indication.

The advantages of the processing method are substantially the same as the advantages of the abovementioned transmission method.

In a first embodiment of the invention, the inhibiting step is intended to be executed by a call signal management unit included in a network element to which the called device is connected.

Thus, in the context of this first embodiment, the called device does not need to be modified or adapted to implement the present invention. It is therefore possible, for example, to use conventional telephone terminals.

According to a second embodiment of the invention, the inhibiting step is intended to be executed by a call signal management unit included in the called device.

Thus, in the context of this second embodiment, a network element to which the called device is connected in order to link it to the communication network does not need to be modified or adapted to implement the present invention. It is therefore possible, for example, to use a conventional network element to link the called device to the communication network.

According to a characteristic of the invention, at least one of the services being a local messaging service managed by a local messaging device connected to the called device, the call signal management unit sends a V.23 signal to the called device in order to inhibit the local messaging device for the call.

Thus, in a particular example compliant with the invention, the V.23 signal is sent in parallel to the called device and to the local messaging device (or telephone answering machine) which is connected in parallel with the called device. If the called device is a standard device, then it does not carry out any particular processing on receiving the V.23 signal. However, on presentation of the incoming call, the V.23 signal is interpreted by the telephone answering machine which inhibits the answering machine function notably if the call is unanswered.

According to another characteristic of the invention, at least one of the services being a network messaging service specific to the communication network, the call signal management unit inhibits the network messaging service for the call.

The invention also relates to a computer program product that can be downloaded from a communication network and/or stored on a medium that can be read by computer and/or executed by a microprocessor, comprising program code instructions to implement the processing method as previously described.

The invention also relates to a network element comprising means of receiving a call signal generated by a calling device in order to set up a call with a called device via at least one communication network, the network element also comprising:
means of detecting the presence of an indication inhibiting at least one service associated with the called device in said call signal;
means of inhibiting said at least one service, said inhibiting means being activated if said call signal comprises said inhibiting indication.

Such a network element can in particular implement, at least partly, the processing method as previously described.

The invention also relates to a called device comprising means of receiving a call signal generated by a calling device in order to set up a call with a called device via at least one communication network, the called device also comprising a management unit comprising:
means of detecting the presence of an indication inhibiting at least one service associated with the called device in said call signal;
means of inhibiting said at least one service, said inhibiting means being activated if said call signal comprises said inhibiting indication.

Such a called device can in particular implement, at least partly, the processing method as previously described.

The invention also relates to a call signal generated by a calling device in order to set up a call with a called device via at least one communication network, the call signal comprising a command inhibiting at least one service associated with the called device enabling the calling device to inhibit said at least one service.

The call signal can obviously comprise the various characteristics relating to the transmission and processing methods according to the invention described previously.

The invention also relates to a modified call signal generated by a calling device or a network element in order to set up a call with a called device via at least one communication network, the call signal comprising an indication inhibiting at least one service associated with the called device enabling the calling device to inhibit said at least one service.

This call signal can obviously comprise the various characteristics relating to the transmission and processing methods according to the invention described previously.

### 5. LIST OF FIGURES

Other characteristics and advantages of the invention will become more clearly apparent from reading the following description of an embodiment, given as an illustrative and nonlimiting example, and the appended drawings, in which:

FIG. 1 presents a diagram of a global network in which an embodiment of the invention is implemented;

FIG. 2 is a flow diagram of the steps of a method of generating an indication inhibiting at least one messaging service according to the abovementioned embodiment;

FIG. 3 is a flow diagram of the steps of the abovementioned method of generating an inhibiting indication in the case where the calling party does not dial the prefix;

FIG. 4 is a flow diagram of the abovementioned method of generating an inhibiting indication in the case where the calling party dials the prefix;

FIGS. 5A to 5C illustrate first examples of call signal interchanges between analog terminals in a PSTN network;

FIGS. 6A and 6B illustrate second examples of call signal interchanges between an analog terminal and a mobile terminal with call forwarding (FIG. 6A) or without call forwarding (FIG. 6B);

FIGS. 7A to 7C illustrate third examples of call signal interchanges between analog terminals (FIGS. 7A and 7B) or between mobile terminal and an analog terminal (FIG. 7C) via a VoIP network;

FIGS. 8A to 8D illustrate fourth examples of call signal interchanges between analog terminals in a VoIP network (FIG. 8A) and between computers and analog or computer terminal (FIGS. 8B to D);

FIG. 9 is a simplified flow diagram of the steps of a method of processing the indication inhibiting at least one voice messaging service according to the invention;

FIG. 10 is a detailed flow diagram of the steps of the abovementioned method of processing the inhibiting indication;

FIGS. 11A and 11B illustrate two examples of implementation of the abovementioned processing method by the LS 103 respectively in the case where the called terminal is the telephone terminal 3B (FIG. 11A) and the telephone terminal 2B (FIG. 11B);

FIG. 12 illustrates an example of implementation of the abovementioned processing method by the MSC 203 in the case where the called terminal is the mobile terminal 5B;

FIG. 13 illustrates an example of implementation of the abovementioned processing method by the PBX 4B in the case where the called terminal is the telephone terminal 4B1;

FIG. 14 illustrates an example of implementation of the abovementioned processing method by the VoIP GK 502 then by the BOX 6B in the case where the called terminal is the telephone terminal 6B1;

FIG. 15 illustrates an example of implementation of the abovementioned processing method by the VoIP GK 502 then by the BOX 7B in the case where the called terminal is the telephone terminal 7B1;

FIG. 16 illustrates an example of implementation of the abovementioned processing method by the VoIP GK 502 then by the BOX 7B in the case where the called terminal is the telephone terminal 7B2;

FIG. 17 illustrates an example of implementation of the abovementioned processing method in the case where the called party has configured unconditional call forwarding from the analog telephone terminal 2B connected to the LS 103 to the mobile terminal 5B;

FIG. 18 illustrates an example of implementation of the abovementioned processing method in the case where the called party has configured unconditional call forwarding from the terminal 2B connected to the LS 103 to the terminal 7B1 connected to the BOX 7B.

### 6. DESCRIPTION OF AN EMBODIMENT OF THE INVENTION

Hereinafter, the context of a voice and/or video messaging service is assumed. According to variants, this service can also be any other service as stated previously.

In the context of an embodiment of the invention, the particular case where a calling user A, from a calling terminal, wants to set up a call by telephony (of course, according to a variant of the invention, this can be a videophone call), via at least one communication network, with a called terminal available to a called user B, is assumed.

It is assumed for example that the calling user dials the number 0296053859, this being the number of the called party B.

If this calling user wants to be sure of not being redirected to a voice messaging service associated with the called terminal (and therefore with this dialed number), then he dials a particular prefix designated XXX before dialing the abovementioned number (of course, as stated previously, according to a variant of the invention, he can also dial a particular suffix after the abovementioned number). The prefix is an inhibiting command in the context of this embodiment.

Of course, the invention also applies to the case of a communication network with terminals making videophone calls (or even purely video calls). Also, the invention equally applies to any type of messaging service such as a video messaging service or a videophone messaging service.

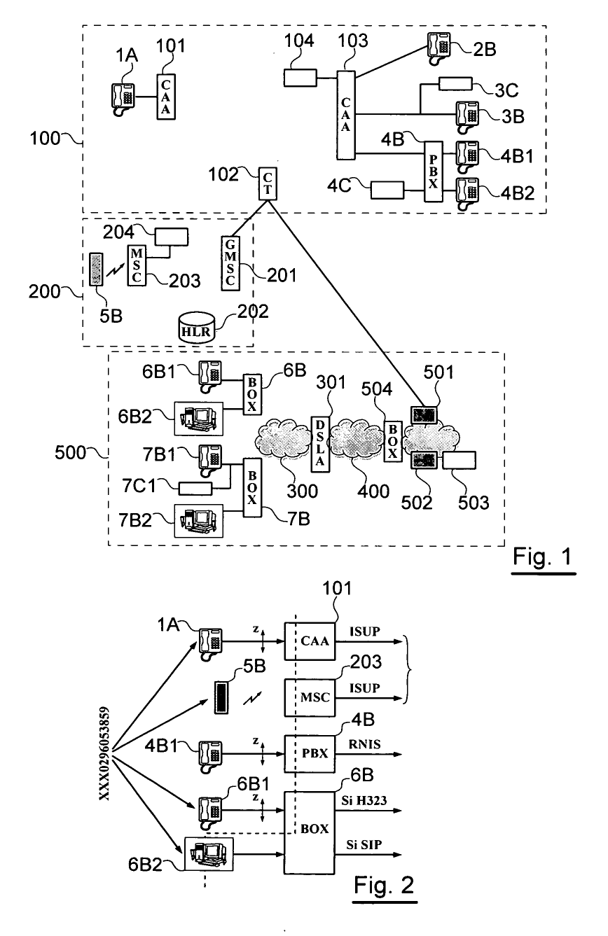

It is assumed hereinafter that said at least one communication network is the global network illustrated by the diagram of FIG. 1. This global network comprises three main networks: a switched telephone network PSTN 100, a GSM-type mobile network 200 and an H.323 or SIP (“Session initiation Protocol”) type VoIP network 500.

The PSTN network 100 comprises:
two local switches, hereinafter designated LS 101 and 103;
a transit switch, hereinafter designated TS 102 handling the following functionalities:
   routing of the calls between the various LSs 101 and 103;
   interfacing between the PSTN network 100 and the mobile network 200;
   interfacing between the PSTN network 100 and the VoIP network 500;
   network voice messaging 104 installed by the operator for all or some of his customers.

The PSTN network 100 has connected to it a set of telephone installations, each of them having a specific configuration, including in particular:
an analog telephone terminal 1A which does not have a local answering machine or even network messaging service (the analog telephone terminal 1A is linked to the LS 101 by means of an interface Z);
an analog telephone terminal 2B which has a PSTN network messaging service 104;
an analog telephone terminal 3B associated with a local telephone answering machine 3C;
a PBX (“Private Branch Exchange”) 4B enabling a company to be connected to an ISDN (“Integrated Services Digital Network”) network via a TO/T2 interface. This PBX 4B has its own voice messaging system 4C and manages two telephones with standard analog interface or with proprietary digital interface 4B1 and 4B2.

The analog telephone terminals 2B, 3B and the telephone answering machine 3C are linked to the LS 103 by means of an interface Z.

The mobile network 200 comprises:
a GMSC (“Gateway Mobile Switching Center”) switch 201 (or switching node) enabling interfacing between the mobile network 200 and the PSTN network 100;
an HLR (“Home Location Register”) database 202 for storing the profiles of the customers of the mobile network 200;
an MSC (“Mobile Switching Center”) switch 203. This MSC 203 incorporates a local database VLR (“Visitor Location Register”) not represented in the diagram of FIG. 1;
a mobile network voice messaging service 204 offered to all the GSM
mobile subscribers and interconnected to the switch MSC 203.

This mobile network 200 has connected to it a mobile terminal 5B having the mobile network messaging service 204.

The telephone and/or videophone network VoIP 500 is interconnected:
with PSTN network 100 via a gateway VoIP GW 501 interconnected with the transit switch TS 102;
with a collection network of ATM or Giga-Ethernet type 400 via the Broadband Access Server BAS element 504. This collection network 400 is itself interconnected with an access network 300 of ADSL type via the DSLAM (“Digital Subscriber Line Asymmetric Mode”) element 301.

This telephone and/or videophone network VoIP 500 comprises:
an H.323 gatekeeper (in the case of an H.323 network) or an SIP Proxy (in the case of an SIP network) or even an MGCP (“Media Gateway Control Protocol” call agent, in the case of an MGCP type network) more generally designated by VoIP GK 502;
a telephone and/or videophone VoIP network voice messaging service 503.

This VoIP network 500 has connected to it:
a BOX element 6B handling the ADSL Modem/Router and VoIP Gateway functions. This box (which can, for example, be a “Livebox”, Livebox being a registered trademark of France Telecom) can be used to connect:
   an analog telephone terminal with Z interface referenced 6B1. This element has VoIP network messaging 503;
   a personal computer 6B2 for connection to the Internet via an Ethernet, Bluetooth, WIFI type interface. Furthermore, videophone application software is installed on this personal computer. This software has VoIP network videophone messaging 503.
   a BOX element 7B handling the ADSL Modem/Router and VoIP Gateway functions. This box and making it possible to connect:
      an analog telephone terminal with Z interface referenced 7B1. The telephone terminal 7B1 has associated with it a telephone answering machine with Z interface referenced 7C1;
      a personal computer 7B2 for connection to the Internet via Ethernet, Bluetooth, WIFI type interface. Furthermore, videophone application software is installed on this personal computer. This software has VoIP videophone messaging 503.

Hereinafter, the LSs, PBXs, MSCs, BOXes, PCs with VoIP software are designated under the general category of peripheral elements and the TSs, GMSCs, VoIP GKs, VoIP GWs under the general category of switching nodes.

There follows hereinafter, in relation to FIG. 2, a description of a method of generating an indication inhibiting at least one voice messaging service (calling party side) according to the abovementioned embodiment of the invention.

As stated hereinabove, the context of a calling user having a calling terminal (in FIG. 2: the analog telephone terminal 1A, the mobile terminal 5B, the telephone terminal 4B1, the analog telephone terminal 6B1 and the computer 6B2) connected to a calling peripheral element (respectively, the LS 101, the MSC 203, the PBX 4B, the BOX 6B and the computer 6B2) is assumed.

The calling user wants to set up a bilateral communication with a called user of a called terminal by dialing the telephone number of the called party, for example 0296053859. Thus, a call signal is sent by the calling terminal to the calling peripheral element to which it is directly connected.

If this calling user wants to be sure of not being redirected to a voice messaging service associated with the called terminal, then he dials the particular prefix (or suffix according to a variant) designated by XXX before dialing the abovementioned number.

The calling peripheral element is itself connected to the telephone or videophone network (respectively the PSTN network 100, the mobile network 200, the ISDN network and the VoIP network 500).

Thus, in the context of the method of generating an inhibiting indication according to the embodiment of the invention, a specific software processing is implemented on the call handling state machine (or call signal management unit on the calling party side) of the calling peripheral element of the network to which the calling terminal is connected.

According to a variant of this embodiment of the invention, the call signal management unit on the calling party side is included in the calling terminal.

This specific software processing comprises a step for detections by the calling peripheral element of the abovementioned telephone or videophone network in the dialing phase making it possible for the calling user to set up a call, of the presence or absence of the prefix XXX in the number dialed and enabling the calling party to inhibit any messaging service of the called party.

This processing comprises a step for deleting the prefix XXX (if it is dialed) from the call signal (respectively IAM, IAM, Setup, Setup and Invite) implemented by the calling peripheral element after having received the call signal sent by the called terminal.

This processing comprises a step for assigning a value to an inhibiting field, hereinafter designated “Voice/Video Mail” field (the value of this field is an inhibiting indication in the context of this embodiment of the invention) incorporated in the call signal (respectively: ISUP IAM message, ISUP IAM message, ISDN SETUP message, H.323 SETUP message and SIP INVITE message) according to the presence or absence of the prefix XXX enabling the calling party to request the inhibiting of the messaging service on the called party side.

The calling peripheral element assigns the “Voice/Video Mail” field the value FALSE if the prefix XXX is dialed and the value TRUE otherwise.

Thus, the calling peripheral element replaces the prefix (inhibiting command) with a value of the inhibiting field (inhibiting indication) in the call signal when it receives the latter. Once this replacement is completed, the calling peripheral element transmits the duly modified call signal to a called peripheral element (described hereinafter).

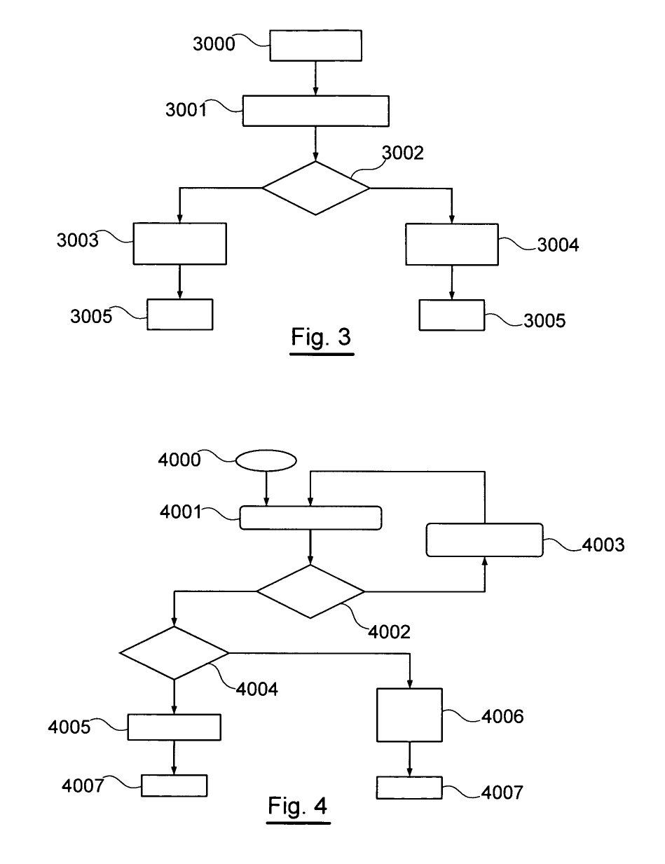

The method of generating the indication inhibiting at least one voice messaging service according to the embodiment of the invention is presented, in relation to FIG. 3, in the case where the calling user does not dial the prefix XXX in the number dialed. This method is implemented mainly on the calling peripheral element.

In a step 3000, the method is initialized.

In a step 3001 the calling party dials the number to reach the called party (by telephony or videophony) without dialing the prefix XXX enabling the calling party to request the inhibiting of the messaging service of the called party.

In a step 3002, the calling peripheral element checks whether it complies with the generation method according to the invention.

Whether the calling peripheral element is equipped with the generation method according to the invention or not, it generates (respectively in the steps 3003 and 3004) the call signal (respectively ISUP, ISUP, ISDN, H.323 and SIP) for reaching the called party. In this case, the call signal comprises in particular:
a called party number corresponding to the number dialed by the calling party;
a calling party number which is supplied by the calling peripheral element (with or without CLIR service).

Since the calling party has not dialed the prefix XXX, the value TRUE is assigned to the “Voice/Video Mail” field by the calling peripheral element.

In steps 3005, the method is terminated.

The method of generating the indication inhibiting at least one voice messaging service according to the embodiment of the invention is presented, in relation to FIG. 4, in the case where the calling user dials the prefix XXX in the number dialed. This method is implemented mainly on the calling peripheral element.

In a step 4000, the method is initialized.

In a step 4001, the calling party dials the number to reach the called party (by telephony or videophony) by adding the prefix XXX enabling the calling party to request the inhibiting of the messaging service of the called party.

In a step 4002, the calling peripheral element checks whether it conforms to the generation method according to the invention.

In a step 4003, if the calling peripheral element is not equipped with the generation method according to the invention, it generates a voice announcement telling the calling party that the called party number dialed is not valid and prompting him to renew his call with an appropriate number, then the call request is released. Then the step 4001 is repeated for a new call.

In a step 4004, if the calling peripheral element is equipped with the generation method according to the invention, it checks whether the calling subscriber (or, in a variant of this embodiment, whether the calling terminal) is authorized to use the service for deactivating the messaging service of the called party.

In a step 4005, if the calling subscriber is authorized to use the service for deactivating the messaging service of the called party, then the calling peripheral element generates the modified call signal (respectively ISUP, ISUP, ISDN, H.323 and SIP) for reaching the called party.

In this case, the modified call signal comprises in particular:
called party number corresponding to the number dialed by the calling party in which the prefix XXX has been deleted;
a calling party number which is supplied by the calling peripheral element (with or without CLIR service).

Because the calling party has dialed the prefix XXX, the value FALSE is assigned to the “Voice/Video Mail” field by the calling peripheral element.

In a step 4006, if the calling subscriber is not authorized to use the service for deactivating the messaging service of the called party, then the calling peripheral element can adopt the following two strategies.

According to a first embodiment of the invention, the calling peripheral element broadcasts a voice announcement to the calling party telling him that he does not have the right to use the service for deactivating the messaging service of the called party and prompting him to renew his call with an appropriate number; then, the call request is released.

According to a second embodiment of the invention, the calling peripheral element generates the modified call signal (respectively ISUP, ISUP, ISDN, H.323 and SIP) for reaching the called party.

In this case, the modified call signal comprises in particular:
a called party number corresponding to the number dialed by the calling party in which the prefix XXX has been deleted;
a calling party number which is supplied by the calling peripheral element (with or without CLIR service).

Because the user has dialed the prefix XXX although he does not have the right to use this service, the value TRUE is assigned to the “Voice/Video Mail” field by the peripheral element.

The “Voice/Video Mail” inhibiting field is instantiated in the call signal, in the minimal form of a boolean and is transported and/or relayed transparently through all the network sections used.

Such is particularly the case between particular networks (for example, between the PSTN 100, mobile 200 and VoIP 500 networks) controlled by one and the same telecommunications operator and/or between different networks operated by different telecommunications operators.

Then the method is terminated in a step 4007.

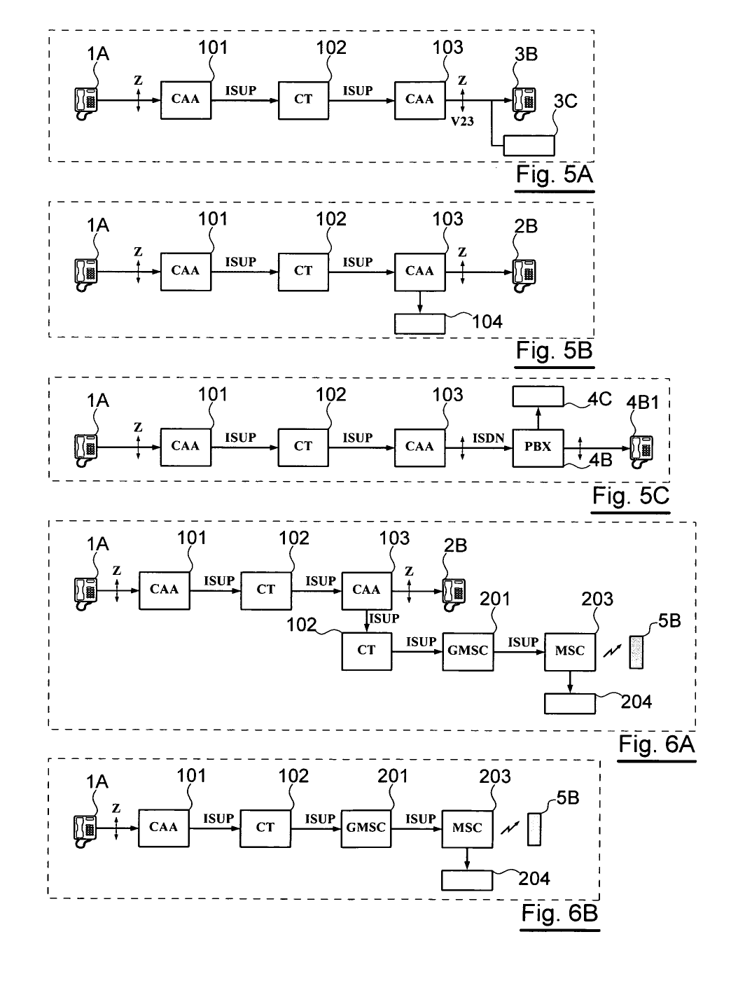

First examples of call signal interchanges between the analog telephone terminal 1A and the analog telephone terminal 3B (FIG. 5A), the analog telephone terminal 2B (FIG. 5B) or the terminal 4B1 (FIG. 5C) are illustrated in relation to FIGS. 5A to 5C.

FIG. 5A corresponds to a PSTN call between a calling subscriber from the terminal 1A and a called subscriber having the terminal 3B. The subscribers are attached to the local switches LS 101 and 103, which are themselves interconnected through the transit switch TS 102, the called party having a telephone answering machine 3C local to his terminal installation 3B.

FIG. 5B corresponds to a PSTN call between a calling subscriber from the terminal 1A and a called subscriber having the terminal 2B. The subscribers are attached to the local switches LS 101 and 103, which are themselves interconnected through the transit switch TS 102, the called party having a network voice messaging service 104.

FIG. 5C corresponds to a PSTN call between a calling subscriber from the terminal 1A and a called subscriber. The subscribers are attached to the local switches LS 101 and 103, which are themselves interconnected through the transit switch TS 102, the called party having a professional-type terminal installation reliant on the PBX 4B, the local voice messaging service 4C and the telephone terminal 4B1.

Second examples of call signal interchanges between the analog telephone terminal 1A and the mobile terminal 5B via call forwarding (FIG. 6A) or without call forwarding (FIG. 6B) are illustrated in relation to FIGS. 6A and 6B.

FIG. 6A corresponds to a PSTN call between a calling subscriber from the terminal 1A and a called subscriber having the terminal 2B. The subscribers are attached to the local switches LS 101 and 103, which are themselves interconnected through the transit switch TS 102.

The called party has generated, via his telephone terminal 2B, unconditional call forwarding to his mobile terminal 5B. The call signal passes through the transit switch 102 to be routed to the GSMC switching node 201 of the mobile network 200 then to the mobile switch MSC 203, the latter having a connection to the mobile voice messaging service 204.

FIG. 6B corresponds to a call from a PSTN subscriber calling from the terminal 1A connected to the switch LS (101) to a called subscriber having the mobile terminal 5B.

The call signal passes through the transit switch 102 to be routed to the switching node GSMC 201 of the mobile network 200 then to the mobile switch MSC 203, the latter having a connection to the mobile voice messaging service 204.

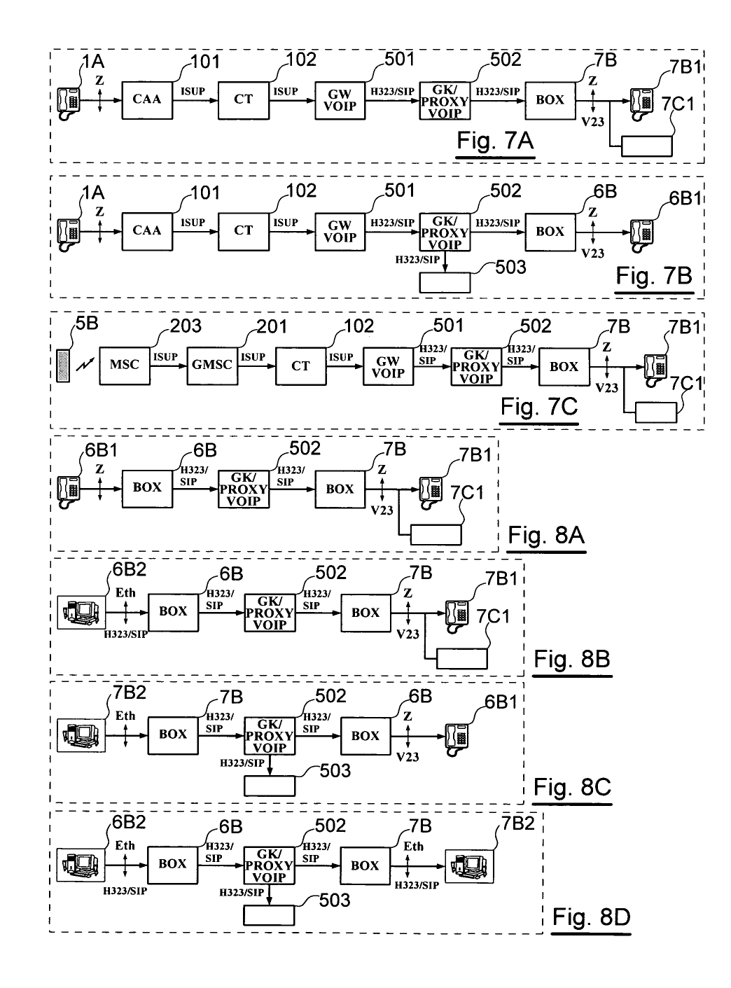

Third examples of call signal interchanges between the analog telephone terminal 1A and the analog telephone terminal 7B1 (FIG. 7A), between the analog telephone terminal 1A and the telephone terminal 6B1 (FIG. 7B) and between the mobile terminal 5B and the telephone terminal 7B1 (FIG. 7C) are illustrated in relation to FIGS. 7A to 7C.

FIG. 7A corresponds to a call from a PSTN subscriber attached to the switch LS 101 to a VoIP subscriber having the BOX element 7B to which the analog telephone terminal 7B1 and the answering machine 7C1 local to the terminal installation are connected.

The call signal passes through the transit switch 102 to be routed to the switching node VoIP GW 501 of the VoIP network 500, then to the server VoIP GK 502 of Gatekeeper type (if the VoIP network 500 is of H.323 type) or of Proxy type (if the VoIP network 500 is of SIP type) or even of Call Agent type (if the VoIP network 500 is of MGCP type).

FIG. 7B corresponds to a call from a PSTN subscriber attached to the switch LS 101 to a VoIP subscriber having the BOX equipment 6B to which the analog telephone terminal 6B1 is connected.

The call signal passes through the transit switch 102 to be routed to the switching node VoIP GW 501 of the VoIP network 500, then to the server VoIP GK 502 of Gatekeeper type (if the VoIP network 500 is of H.323 type) or of Proxy type (if the VoIP network 500 is of SIP type), or even of Call Agent type (if the VoIP network 500 is of MGCP type). The VoIP network 500 offers a messaging service 503.

FIG. 7C corresponds to a call from a subscriber having the mobile terminal 5B temporarily attached to the switch MSC 203 to a VoIP subscriber having the BOX equipment 7B to which the analog telephone terminal 7B1 and the answering machine 7C1 local to the terminal installation (telephone terminal 7B1) are connected.

The call signal passes through the entry/exit point GMSC 201 of the mobile network 200, then through the transit switch 102 to be routed to the entry point (or switching node) VoIP GW 501 of the VoIP network 500, then to the server VoIP GK 502 of Gatekeeper type (if the VoIP network 500 is of H.323 type) or of Proxy type (if the VoIP network 500 is of SIP type), or even of Call Agent type (if the VoIP network 500 is of MGCP type).

Fourth examples of call signal interchanges between the analog telephone terminal 6B1 and the analog telephone terminal 7B1 (FIG. 8A), between the personal computer 6B2 and the analog telephone terminal 7B1 (FIG. 8B), between the personal computer 7B2 and the analog telephone terminal 6B1 (FIG. 8C) and between the personal computer 6B2 and the personal computer 7B2 (FIG. 8D) are illustrated in relation to FIGS. 8A to 8D.

FIG. 8A corresponds to a call from a VoIP subscriber having the analog telephone terminal 6B1 connected to the BOX equipment 6B to a VoIP subscriber having the BOX equipment 7B to which the analog telephone terminal 7B1 and the answering machine 7C1 local to the terminal installation (telephone terminal 7B1) are connected.

The call signal passes through the server VoIP GK 502 of Gatekeeper type (if the VoIP network 500 is of H323 type) or of Proxy type (if the VoIP network 500 is of SIP type), or even of Call Agent type (if the VoIP network 500 is of MGCP type).

FIG. 8B corresponds to a call from the computer 6B2 (provided with telephony and/or VoIP videophony software itself handling the H.323 or SIP call signals) connected via an Ethernet-type interface to the BOX equipment 6B to another VoIP subscriber having the BOX equipment 7B to which are connected the analog terminal 7B1 and the answering machine 7C1 local to the terminal installation (telephone terminal 7B1).

The call signal passes through the VoIP GK server 502 of Gatekeeper type (if the VoIP network 500 is of H.323 type) or of Proxy type (if the VoIP network 500 is of SIP type), or even of Call Agent type (if the VoIP network 500 is of MGCP type).

FIG. 8C corresponds to a call from the computer 7B2 (provided with telephony and/or VoIP videophony software itself handling the H.323 or SIP call signals) connected via an Ethernet-type interface to the BOX equipment 7B to a VoIP subscriber having the BOX equipment 6B to which the analog telephone terminal 6B1 is connected.

The call signal passes through the VoIP GK server 502 of Gatekeeper type (if the VoIP network 500 is of H.323 type) or of Proxy type (if the VoIP network 500 is of SIP type), or even of Call Agent type (if the VoIP network 500 is of MGCP type), the VoIP network 500 having its own network messaging 503.

FIG. 8D corresponds to a call from the computer 6B2 (provided with telephony and/or VoIP videophony software itself handling the H.323 or SIP call signals) connected via an Ethernet-type interface to the BOX equipment 6B to a VoIP subscriber having the BOX equipment 7B to which the computer 7B2 (provided with telephony and/or videophony software) is connected via an Ethernet interface.

The call signal passes through the VoIP GK server 502 of Gatekeeper type (if the VoIP network 500 is of H.323 type) or of Proxy type (if the VoIP network 500 is of SIP type), or even of Call Agent type (if the VoIP network 500 is of MGCP type), the VoIP network 500 having its own network messaging 503.

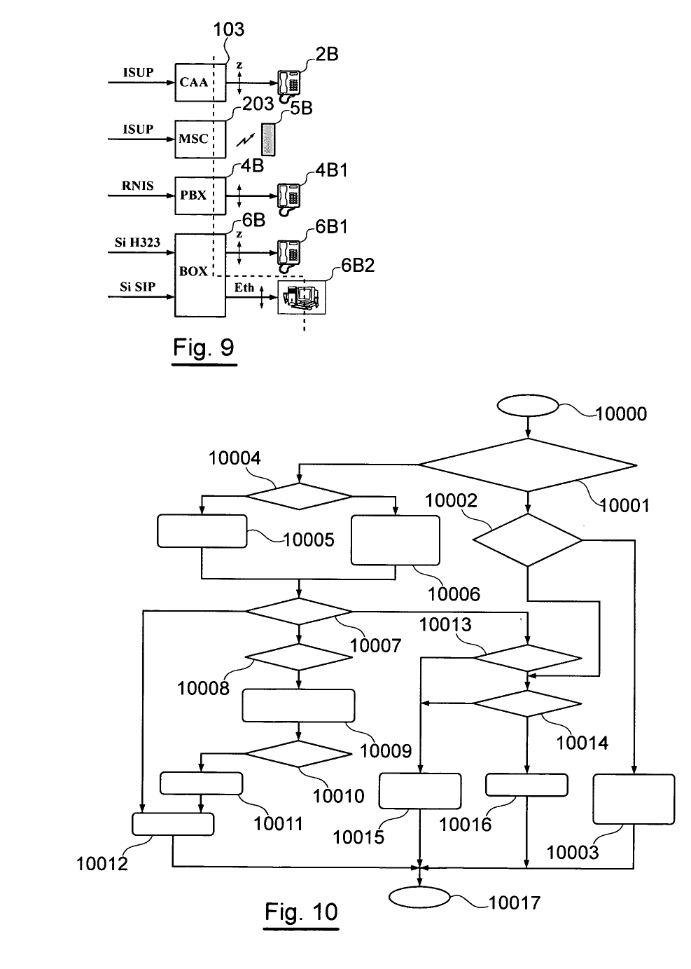

A method of processing the indication inhibiting at least one voice (or videophone) messaging service according to the abovementioned embodiment of the invention is described hereinafter in relation to FIG. 9. As stated hereinabove, the context of the calling user who wants to set up a bilateral communication with the called user is assumed.

The called user has a called terminal (in FIG. 9: the analog telephone terminal 2B, the mobile terminal 5B, the telephone terminal 4B1, the analog telephone terminal 6B1 or the computer 6B2) connected to a called peripheral element (respectively, the LS 103, the MSC 203, the PBX 4B, the BOX 6B and the computer 6B2).

The called peripheral element is itself connected to the telephone or videophone network (respectively the PSTN network 100, the mobile network 200, the ISDN network and the VoIP network 500).

The LS 103 (called peripheral element) is responsible for the analog terminal 2B (called terminal) on receiving the USP call presentation IAM message (or modified call signal).

The MSC 203 (called peripheral element) is responsible for the mobile terminal 5B (called terminal) on receiving the ISUP call presentation IAM message (or modified call signal).

The PBX 4B (called peripheral element) is responsible for the analog terminal or terminal with proprietary interface 4B1 (called terminal) on receiving the ISDN call presentation SETUP message (or modified call signal).

The BOX element 6B (called peripheral element) is responsible for the analog terminal 6B1 (called terminal) on receiving the SETUP message (in the case of use of the H.323 VoIP protocol) or INVITE message (in the case of use of the SIP VoIP protocol), or even CRCX (“Create Connection”) (if the VoIP network 500 is of MGCP type).

The computer 6B2 (called peripheral element) is responsible for the computer 6B2 (called terminal) on receiving the SETUP message (in the case of use of the H.323 VoIP protocol) or INVITE message (in the case of use of the SIP VoIP protocol), or even CRCX (“Create Connection”) (if the VoIP network 500 is of MGCP type).

Thus, in the context of the implementation of the method of processing the inhibiting indication, a specific software processing is implemented on the call handling state machine (or call signal management unit on the called party side) of the called peripheral element of the network to which the called terminal is connected.

According to a variant of this embodiment of the invention, the call signal management unit on the called party side is included in the called terminal.

The method of processing the indication inhibiting at least one voice messaging service according to the abovementioned embodiment of the invention which is implemented mainly on the called peripheral element is described in detail in relation to FIG. 10.

In a step 10000, the method is initialized.

In a step 10001, the call signal is presented to the abovementioned called peripheral element handling the subscriber using the called terminal. This peripheral element checks whether unconditional call forwarding has been implemented by the called party himself (for example by entering the symbols: *21*N° from the called terminal, which is how to generate unconditional call forwarding in FRANCE TELECOM's PSTN network).

Advantageously, the called peripheral element checks that the call presented is not already forwarded. If it is, for example if call forwarding is implemented locally, the call will be broken by this called peripheral element so as to avoid network loops.

In a step 10002, if unconditional call forwarding is implemented on the called peripheral element, this called peripheral element checks whether the call forwarding is directed to a voice messaging service (for example a network messaging service 104, 204, 503, 4C) or to a telephone number (for example a fixed or mobile telephone).

It is assumed that the configuration service of the unconditional call forwarding previously implemented checks and validates the forwarding number. In particular, if the line to which the forwarding number corresponds is not attached to a network voice messaging service, then the unconditional call forwarding to the messaging service will not be allowed. Similarly, the call forwarding will not be allowed by the configuration service of the call forwarding if the unconditional forwarding number thought to correspond to a line number is incorrect or is not authorized (for example, if it corresponds to an international number, or if it corresponds to the same number as the called party, or for any other reason).

If the call forwarding is directed to a voice messaging service, then the step 10014 described hereinafter is implemented.

In a step 10003, in the case of unconditional call forwarding to a correct and authorized telephone number, the called peripheral element extends the call signaling by modifying it (for example by adding a “Redirecting Number” field to which the value of the number requested by the calling party is assigned, then by setting the call forwarding counter to 1, then by replacing the called number with the valid number configured for the unconditional call forwarding). Then, the method is terminated in a step 10017.

In a step 10004, if no unconditional call forwarding is implemented on the called peripheral element, then this called peripheral element checks whether the call signal comprises the “Voice/Video Mail” field and checks the value that is assigned to it (TRUE or FALSE).

In a step 10005, if the call signal does not comprise the “Voice/Video Mail” field or if the field has the value TRUE in the call signal, then the called peripheral element presents the incoming call normally to the called terminal.

In a step 10006, if the call signal comprises the “Voice/Video Mail” field to which the value FALSE is assigned, and if the called peripheral element is of LS type (for example the LSs 101 or 103) or BOX type (for example the BOXes 6B or 7B) or of PBX type to Z interface, then, after having received the incoming call signal, it generates an outgoing call signal compliant with the V.23 protocol (hereinafter also designated “V.23 modulation”) that it transmits over the telephone line (via a Z interface) to the called terminal and to the local messaging device if appropriate (if the called terminal has such a local messaging device). In this outgoing call signal, the called peripheral element adds a “Voice/Video Mail” field compliant with the V.23 protocol, to which it gives, for example, a value “FALSE”. This field is interpreted only by the messaging device if present, the latter having a software adaptation enabling it to perform this interpretation.

The interpretation of the FALSE value of the “Voice/Video Mail” field of the call signal causes the messaging device not to function.

For the other types of called peripheral elements (MSC, PBX with digital or proprietary interface, H.323/SIP terminals), the incoming call is presented normally to the called terminal.

In a step 10007, the called peripheral element checks the state of the called terminal (busy or not) and the availability of the called user.

Advantageously, in a step 10008, if the called terminal is in the busy state, the called peripheral element checks whether the called party has subscribed to the “Call Waiting” service.

In a step 10009, if the called party has subscribed to the “Call Waiting” service, then the called peripheral element sends call notification beeps to the called party then broadcasts a voice announcement to the calling party telling him that the called party is on line and being informed of this call.

In a step 10010, the called user can choose to reject or accept this call.

In a step 10011, the called party accepts this call by using the keys of the called terminal, then the preceding call (which is still in progress for the called party) can be put on hold (for example, in this case, the system broadcasts music-on-hold to the called party) or even released.

In a step 10012, with the called party having put on hold the preceding call or having broken off his communication associated with the preceding call, the calling party and the called party are connected bidirectionally and the method is terminated in a step 10017.

In a step 10013, if the called party does not accept the call or if the called terminal is busy,
the called party does not have the “Call waiting” service or,
if he has it, he does not accept the call,
   then the called peripheral element checks whether the called party has a network messaging service.

In a step 10014, if the called party has a network messaging service and if one of the possible call forwarding conditions is satisfied (for example, no answer from the called party, busy, unconditional call forwarding, etc.) then the called peripheral element checks whether the call signal comprises the “Voice/Video Mail” field and checks the value that is assigned to it.

In a step 10015,
if the called party does not have network messaging or
if the call signal comprises the “Voice/Video Mail” field to which the value FALSE is assigned,
   then the incoming call is released (for example, a busy tone is broadcast to the calling party if the called party is busy or a call ringing tone is broadcast to the calling party for a certain time if the call is unanswered).

In a step 10016, if the called party has a network messaging service and if one of the possible call forwarding conditions is satisfied (for example, no answer from the called party, busy, unconditional call forwarding, etc.) and
if the “Voice/Video Mail” field, being present in the call signal, has the value TRUE or
if this field is not present in the call signal,
   then the calling party is connected by the called peripheral element to the network messaging service.

In the context of the examples described hereinbelow, it is assumed that the peripheral elements concerned implement the abovementioned method processing the indication inhibiting at least one voice messaging service.

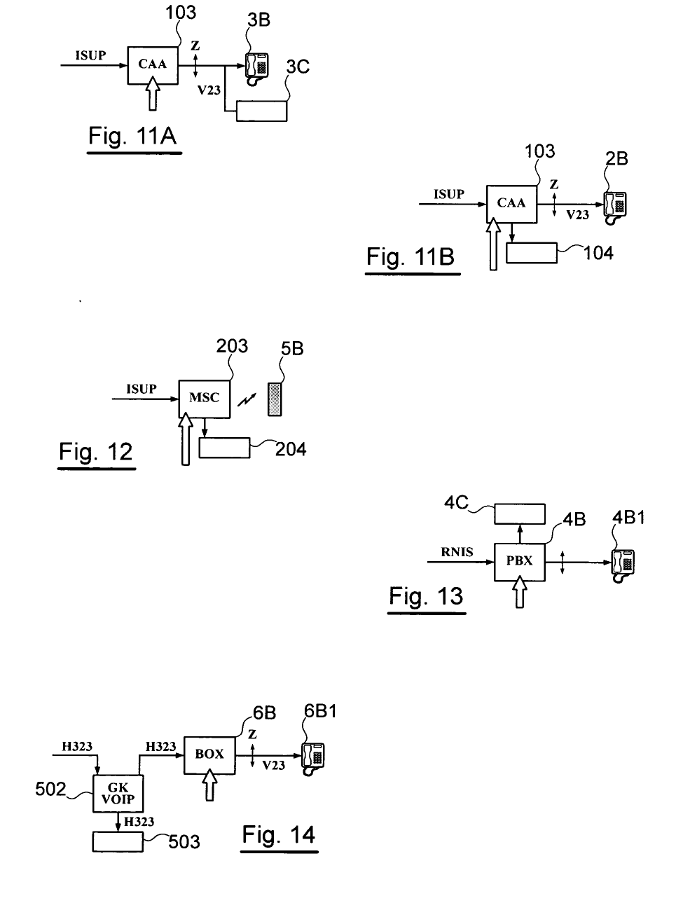

Two examples of implementation of the method of processing the inhibiting indication according to the embodiment of the invention by the LS 103 are illustrated in relation to FIGS. 11A and 11B, respectively in the case where the called terminal is the telephone terminal 3B (FIG. 11A) and the telephone terminal 2B (FIG. 11B).

Thus, the LS 103 (called peripheral element) receives an ISUP IAM call signal which comprises the “Voice/Video Mail” field (inhibiting indication).

In the case of FIG. 11A, the analog telephone terminal 3B has a local telephone answering machine 3C. If the “Voice/Video Mail” field has the value FALSE, then the LS 103 generates a V.23 modulation in the phase of call presentation to the analog terminal 3B and to the telephone answering machine 3C which inhibits the latter in case of no answer from the analog terminal 3B.

In the case of FIG. 11B, the analog telephone terminal 2B has a PSTN network messaging service 104. If the “Voice/Video Mail” field has the value FALSE, then the LS 103 does not redirect the call to the network messaging 104 for the set of events that can lead to this state (no answer, busy, unconditional call forwarding to messaging service, etc.) but acts from a call signaling point of view as if the called party did not have network voice messaging. Furthermore, the LS 103 generates a V.23 modulation on the phase of call presentation to the analog terminal 2B, which makes it possible to inhibit line seizure by any telephone answering machine installed locally on the terminal 2B.

An example of implementation of the method of processing the inhibiting indication according to the embodiment of the invention by the MSC 203 in the case where the called terminal is the mobile terminal 5B is illustrated in relation to FIG. 12.

Thus, the MSC 203 (called peripheral element) receives an ISUP IAM call signal which comprises the “Voice/Video Mail” field (inhibiting indication).

In this example, the mobile terminal 5B has a GSM mobile network messaging service 204. If the “Voice/Video Mail” field has the value FALSE, then the MSC 203 attached to the mobile terminal 5B does not redirect the call to the mobile network messaging service 204 for the set of events that can lead to this state (no answer, busy, unconditional call forwarding to messaging service, etc.), but acts from a call signaling point of view as if the called party did not have network voice messaging.

An example of implementation of the method of processing the inhibiting indication according to the embodiment of the invention by the PBX 4B in the case where the called terminal is the telephone terminal 4B1 is illustrated in relation to FIG. 13.

Thus, the PBX 4B (called peripheral element) receives an ISDN setup call signal which comprises the “Voice/Video Mail” field (inhibiting indication).

In this example, the telephone terminal 4B1 (which either has Z interface or proprietary interface) has the messaging service 4C. If the “Voice/Video Mail” field has the value FALSE, then the PBX 4B does not redirect the call to the messaging service 4C for the set of events that can lead to this state (no answer, busy, unconditional call forwarding to messaging service, etc.) but acts from a call signaling point of view as if the called party did not have voice messaging. Furthermore, if the telephone terminal 4B1 has Z interface, the PBX 4B generates a specific V.23 modulation in the phase of call presentation to the telephone terminal 4B1, which makes it possible to inhibit line seizure by any telephone answering machine installed locally on the terminal 4B1.

An example of implementation of the method of processing the inhibiting indication according to the embodiment of the invention by the VoIP GK 502 then by the BOX 6B in the case where the called terminal is the telephone terminal 6B1 is illustrated in relation to FIG. 14.

In the context of this example, the VoIP GK 502 is an H.323 gatekeeper.

Thus, the VoIP GK 502 receives an H.323 Setup call signal which comprises the “Voice/Video Mail” field.

In this example, the telephone terminal 6B1 (which has a Z interface) has the VoIP network messaging service 503. If the “Voice/Video Mail” field has the value FALSE, then the VoIP GK 502 does not redirect the call to the VoIP network messaging service 503 for the set of events that can lead to this state (no answer, busy, unconditional call forwarding to messaging service, etc.), but acts from a call signaling point of view as if the called party did not have voice messaging. The H323 call signaling is relayed transparently to the BOX called peripheral element 6B.

If the “Voice/Video Mail” field has the value FALSE, then the BOX 6B generates a V.23 modulation in the phase of call presentation to the telephone terminal 6B1 which makes it possible to inhibit line seizure by any telephone answering machine installed locally on the terminal 6B1.

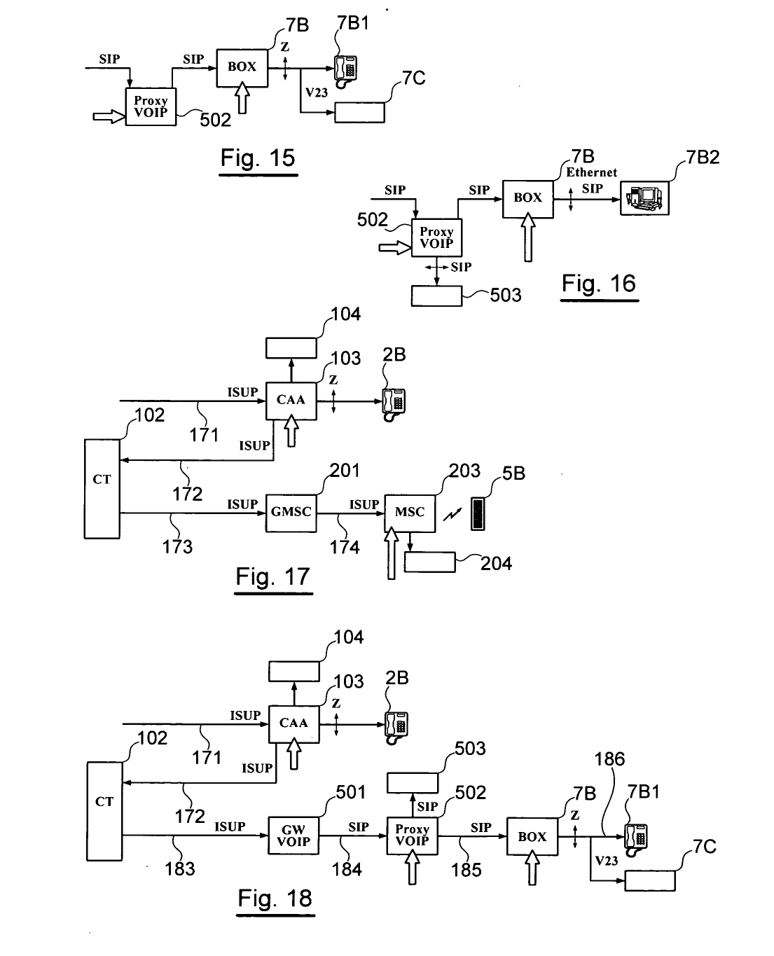

An example of implementation of the method of processing the inhibiting indication according to the embodiment of the invention by the VoIP GK 502 then by the BOX 7B in the case where the called terminal is the telephone terminal 7B1 is illustrated in relation to FIG. 15.

In the context of this example, the VoIP GK 502 is an SIP Proxy.

Thus, the VoIP GK 502 receives an SIP INVITE call signal which comprises the “Voice/Video Mail” field.

In this example, the telephone terminal 7B1 (which has a Z interface) has the telephone answering machine 7C installed locally. Because the VoIP line associated with the telephone terminal 7B1 does not have network voice messaging, the SIP Proxy 502 simply relays the SIP call signaling transparently to the BOX 7B.

If the “Voice/Video Mail” field has the value FALSE, then the BOX 7B generates a V.23 modulation in the phase of call presentation to the analog terminal 7B1 which makes it possible to inhibit line seizure by the telephone answering machine 7C installed locally on the terminal 7B1.

An example of implementation of the method of processing the inhibiting indication according to the embodiment of the invention by the SIP Proxy 502 then by the BOX 7B in the case where the called terminal is the multimedia computer 7B2 (having VoIP software) is illustrated in relation to FIG. 16.

Thus, the SIP Proxy 502 receives an SIP INVITE call signal which comprises the “Voice/Video Mail” field.

In this example, the computer 7B2 (on which SIP telephone software is installed) is connected to the BOX 7B via an Ethernet interface.

The VoIP line associated with the computer 7B2 has network VoIP voice messaging 503. If the “Voice/Video Mail” field has the value FALSE, then the Proxy 502 does not direct the call to the network messaging 503 for the set of events that can lead to this state (no answer, busy, unconditional call forwarding to messaging, etc.), but acts from a call signaling point of view as if the called party did not have voice messaging.

The SIP call signaling is relayed transparently to the BOX 7B which itself relays it to the computer 7B2. If the “Voice/Video Mail” field has the value FALSE and if the SIP telephone software has its own answering machine, then the latter is inhibited.

An example of implementation of the method of processing the inhibiting indication according to the embodiment of the invention in the case where the called party has configured unconditional call forwarding from the analog telephone terminal 2B connected to the LS 103 to the mobile terminal 5B is illustrated in relation to FIG. 17.

On the LS 103, in a step 171, because of the unconditional call forwarding, the call is not presented to the telephone terminal 2B, nor to the network voice messaging 104 that the terminal 2B has.

In a step 172, the LS 103 relays the ISUP IAM call signal to the transit switch 102 by performing the following operations:
adding, to the call signal, a “Redirecting Number” field which contains the number of the line associated with the terminal 2B;
adding, to the call signal, a call forwarding counter initialized to the value 1 (if the call presented in step 171 has already been forwarded, then the LS 103 breaks the call to avoid network loops);
replacing, in the call signal, the called number with the number corresponding to the mobile terminal 5B.

The “Voice/Video Mail” field is unchanged.

In a step 173, the TS 102 relays the call signal to the GMSC 201 which, in a step 174, transmits it to the MSC 203 with which the mobile terminal 5B is associated.

If the “Voice/Video Mail” field has the value FALSE, then the MSC 203 does not redirect the call to the mobile network messaging service 204 for the set of events that can lead to this state (no answer, busy, unconditional call forwarding to message, etc.), but acts from a call signaling point of view as if the called party did not have voice messaging.

An example of implementation of the method of processing the inhibiting indication according to the embodiment of the invention in the case where the called party has configured unconditional call forwarding from the analog telephone terminal 2B connected to the LS 103 to the telephone terminal 7B1 connected to the BOX 7B in illustrated in relation to FIG. 18.

The steps 171 and 172 described previously are also implemented in the context of this example.

In a step 183, the TS 102 relays the call signal to the VoIP GW 501 which is of the SIP type in the context of this example. In a step 184, the VoIP GW 501 converts the call signal into an SIP call signal and transmits the latter to the SIP Proxy 502 interconnected to the network voice messaging service 503.

If the “Voice/Video Mail” field has the value FALSE, then the VoIP GK 502 (SIP proxy) does not redirect the call to the VoIP network messaging service 503 for the set of events that can lead to this state (no answer, busy, unconditional call forwarding to messaging, etc.), but acts from a call signaling point of view as if the called party did not have voice messaging.

In a step 185, the SIP call signal is transmitted transparently by the VoIP GK 502 to the BOX 7B.

If the “Voice/Video Mail” field has the value FALSE, then, in a step 186, the BOX 7B generates a V.23 modulation in the phase of call presentation to the terminal 7B1, which makes it possible to inhibit line seizure by the telephone answering machine 7C installed locally on the terminal 7B1.

1. A method of transmitting an indication inhibiting at least one service associated with a called device, the method including a step for generating a call signal to set up a communication between a calling device and the called device via at least one communication network, said method also comprising a substitution step, to be executed when said call signal comprises an inhibiting command, and during which said inhibiting command is replaced by said inhibiting indication.

2. The method as claimed in claim 1, wherein the substitution step is to be executed for a call signal management unit included in a network element to which the calling device is connected.

3. The method as claimed in claim 1, wherein the substitution step is to be executed by a call signal management unit included in the calling device.

4. The method as claimed in claim 1, wherein said inhibiting command is a prefix dialed by a user of the calling device on generation of the call signal.

5. The method as claimed in claim 1, wherein said inhibition indication is included in at least one field that takes a first value or a second value according to said inhibiting command.

6. The method as claimed in claim 1, further comprising a step for verifying at least one authorization of the calling device and/or of a user of the calling device to inhibit said at least one service.

7. A computer program product that can be downloaded from a communication network and/or stored on a medium that can be read by computer and/or executed by a microprocessor, wherein the computer program comprises program code instructions for implementing the method of claim 1.

8. (canceled)

9. A calling device comprising:
means for generating a call signal in order to set up a call with a called device via at least one communication network;
a call signal management unit; and
means for adding a command to inhibit at least one service associated with the called device to the call signal, wherein the call signal management unit comprises:
means for receiving the call signal; and
means for detecting the presence of the inhibiting command in the call signal; and
means for generating a modified call signal in which, if an inhibiting command is present in the call signal, said inhibiting command is replaced by an inhibiting indication.

10. (canceled)

11. A method of processing an indication for inhibiting at least one service associated with a called device, a calling device being intended to generate a call signal in order to set up a call with the called device via at least one communication network, said method comprising:
a step for inhibiting said service, said step being intended to be executed when the call signal comprises said inhibiting indication.

12. The method as claimed in claim 11, wherein said inhibiting step is to be executed by a call signal management unit included in a network element to which said called device is connected.

13. The method as claimed in claim 11, wherein said inhibiting step is to be executed by a call signal management unit included in said called device.

14. A computer program product that can be downloaded from a communication network and/or stored on a medium that can be read by computer and/or executed by a microprocessor, wherein the computer program comprises program code instructions for implementing the method of claim 11.

15. A device comprising:
means for receiving a call signal generated by a calling device in order to set up a call with a called device via at least one communication network;
means for detecting the presence of an indication for inhibiting at least one service associated with the called device in said call signal; and
means for inhibiting said at least one service, said inhibiting means being activated if said call signal comprises said inhibiting indication.

16. (canceled)

17. A call signal generated by a calling device in order to set up a call with a called device via at least one communication network, wherein the call signal it comprises a command inhibiting at least one service associated with the called device enabling the calling device to inhibit said at least one service.

18. A modified call signal generated by a calling device or a network element in order to set up a call with a called device via at least one communication network, wherein the modified call signal comprises an indication for inhibiting at least one service associated with the called device enabling the calling device to inhibit said at least one service.
